(19) United States
(12) Patent Application Publication
(10) Pub. No.: US 2004/0267087 A1
(43) Pub. Date: Dec. 30, 2004

(54) Incubator

(76) Inventor: Hajime Ogata, Hirakata-shi (JP)

Correspondence Address: JONES DAY, 77 WEST WACKER, CHICAGO, IL, 60601-1692, US

(21) Appl. No.: 10/496,238

(22) PCT Filed: Nov. 20, 2002
(86) PCT No.: PCT/JP02/12107

(30) Foreign Application Priority Data
Nov. 22, 2001 (JP) 2001-375671

(51) Int. Cl. A61G 11/00

(52) U.S. Cl. 600/22

(57) ABSTRACT

An incubator (11) capable of automatically determining a set humidity by a control part in dependence upon a set temperature, wherein, when the inside temperature is newly set or changed to a specified environmental temperature, the set humidity is automatically determined to a value dependent upon the set temperature even if the inside humidity is not set or changed simultaneously, and the inside of the incubator (11) is controlled to the optimum environmental humidity, whereby an incubated baby in the incubator (11) can be easily and surely nursed in an appropriate physiological environment.

### TECHNICAL FIELD

The present invention relates to an incubator, for nursing an incubated baby such as a low birth weight baby, wherein temperature, humidity or others are controlled and therefore an appropriate physiological environment is obtained.

### BACKGROUND ART

FIG. 7 shows an incubator to which the present invention can be applied. In this incubator 11, a transparent hood 12 for accommodating an incubated baby is arranged on a base part 14 on a base platform 13, and the hood 12 is provided with a treatment window 15 for treating the incubated baby in the hood 12, that is, in the incubator from the outside of the hood 12 and a transparent door 16 for opening and closing the treatment window 15. The door 16 and the hood 12 are provided with a door fixing mechanism 17.

The door 16 and the side of the hood 12 are provided with one-touch type portholes 21 and transparent doors 22 for opening and closing the one-touch type portholes 21. The side of the hood 12 is also provided with a diaphragm type porthole (not shown). A bed (not shown) for the incubated baby is arranged in the hood 12 and bed inclining knobs 23 are installed near the treatment window 15. The bed can be inclined by rotating one of the bed inclining knobs 23 and the bed can be regulated in height by rotating both of the bed inclining knobs 23 simultaneously.

A control panel 24 is installed near the bed inclining knobs 23 and the control panel 24 is provided with buttons, displays and others for controlling temperature, humidity and others in the hood 12 to values appropriate to the incubated baby as described later. In the base part 14, there are installed a temperature regulation part, a humidity regulation part and others whose operations are controlled by pressing the buttons on the control panel 24 or others. Casters 25 are installed under the base platform 13.

FIG. 8 shows a part of a control panel 24 in a conventional incubator 11. The control panel 24 is provided with an inside temperature display 31, a set temperature display 32 and direction buttons 33 and 34. By pressing any of the direction buttons 33 and 34, the set temperature displayed on the set temperature display 32 lowers or rises respectively by 0.1° C. at a time. The temperature regulation part operates so that the inside temperature displayed on the inside temperature display 31 becomes equal to the set temperature.

The control panel 24 is also provided with an inside humidity display 35, a set humidity display 36 and a humidity setting button 37. By pressing the humidity setting button 37, the set humidity display 36 lights up and a state arises in which the humidity can be set. By pressing any of the direction buttons 33 and 34 in this state, the set humidity (relative humidity) displayed on the set humidity display 36 lowers or rises respectively by 1% at a time. The humidity regulation part operates so that the inside humidity displayed on the inside humidity display 35 becomes equal to the set humidity.

However, as is apparent from the above explanation, it is necessary in the conventional incubator 11 for a treating person such as a doctor or a nurse to direct the set temperature and the set humidity in independence of each other. As a result, it is difficult to say that the incubated baby in the incubator can easily be nursed in an appropriate physiological environment. Furthermore, since it is necessary to direct the set temperature and the set humidity in independence of each other in this manner, even if the set temperature has been directed, there is a possibility that directing the set humidity is forgotten or an inappropriate set humidity is directed.

In addition, there is a possibility that, when the set temperature is changed, simultaneously changing the set humidity is forgotten or the set humidity is changed to an inappropriate value. For these reasons, it is also difficult in the conventional incubator 11 to say that the incubated baby in the incubator can surely be nursed in an appropriate physiological environment. Therefore, the object of the present invention is to provide an incubator wherein an incubated baby in the incubator can easily and surely be nursed in an appropriate physiological environment.

### DISCLOSURE OF INVENTION

In an incubator according to the present invention, a set humidity is automatically determined in dependence upon a set temperature directed as an inside temperature. For this reason, when a treating person newly directs or changes a set temperature as an inside temperature, a set humidity is automatically determined to a value dependent upon the set temperature even if the treating person does not simultaneously direct or change the set humidity as an inside humidity. Therefore, it is possible to nurse an incubated baby in the incubator easily and surely in an appropriate physiological environment.

In a preferred incubator according to the present invention, the set humidity shows a positive correlation with respect to the set temperature within a set temperature range between a maximum set temperature (Tₘₐₓ) and a minimum set temperature (Tₘᵢₙ), and the set humidity remains equal to a set humidity at the maximum set temperature or the minimum set temperature at the maximum set temperature and up or the minimum set temperature and under. For this reason, the set humidity corresponding to the set temperature directed as the inside temperature is determined to a value most appropriate to an incubated baby in an ordinary state. Therefore, it is possible to nurse an incubated baby in the incubator easily and surely in a most appropriate physiological environment.

In a preferred incubator according to the present invention, a sensor automatically determines the set temperature as the inside temperature in response to body temperature of an incubated baby accommodated in the incubator. For this reason, if only an aimed body temperature of the incubated baby is known, the set temperature is automatically determined to a value dependent upon the body temperature of the incubated baby accommodated in the incubator even if a treating person does not direct or change the set temperature as the inside temperature. Therefore, it is possible to nurse the incubated baby in the incubator in an appropriate physiological environment exceedingly easily and exceedingly surely.

In a preferred incubator according to the present invention, it is possible to direct a predetermined humidity, as a set humidity, independent of the set temperature directed as the inside temperature. For this reason, it is possible to direct a predetermined humidity appropriate to a state of the incubated baby even in case where the state of the incubated baby is different from an ordinary state or in other cases. Therefore, it is possible to nurse the incubated baby in a physiological environment in the incubator appropriate to a state of the incubated baby.

In a preferred incubator according to the present invention, it is displayed on a set humidity direction display that the predetermined humidity, which is independent of the set temperature directed as the inside temperature, is directed as the set humidity. For this reason, it is easily viewed from the outside whether the inside humidity is directed so as to depend upon the set temperature or not to depend upon the set temperature. Therefore, it is possible to change the direction surely in accordance with the state of the incubated baby, and it is possible to nurse the incubated baby in the incubator always in an appropriate physiological environment.

In a preferred incubator according to the present invention, the set humidity display serves as the predetermined humidity direction display, too. For this reason, it is not necessary to arrange the predetermined humidity direction display separately from the set humidity display, and therefore an increase in a manufacturing cost of the incubator is suppressed.

In a preferred incubator according to the present invention, it is possible to change the predetermined humidity. For this reason, it is possible to direct the predetermined humidity appropriate to a state of each incubated baby even in case where the state of the incubated baby is different from an ordinary state or in other cases. Therefore, it is possible to nurse the incubated baby in a physiological environment in the incubator appropriate to a state of each incubated baby.

### BRIEF DESCRIPTION OF DRAWINGS

FIG. 1 is a front view of a principal part in a first mode of the present invention.

FIG. 2 is a graph showing a measured result of a low birth weight baby by the first mode of the present invention.

FIG. 3 is a graph showing a measured result of a low birth weight baby by a second mode of the present invention.

FIG. 4 is a graph showing a measured result of a low birth weight baby by a third mode of the present invention.

FIG. 5 is a graph showing a measured result of a normal birth weight baby by the second mode of the present invention.

FIG. 6 is a front view of a principal part in a fourth mode of the present invention.

FIG. 7 is a perspective view of an incubator to which the present invention can be applied.

FIG. 8 is a front view of a principal part in one conventional mode of the present invention.

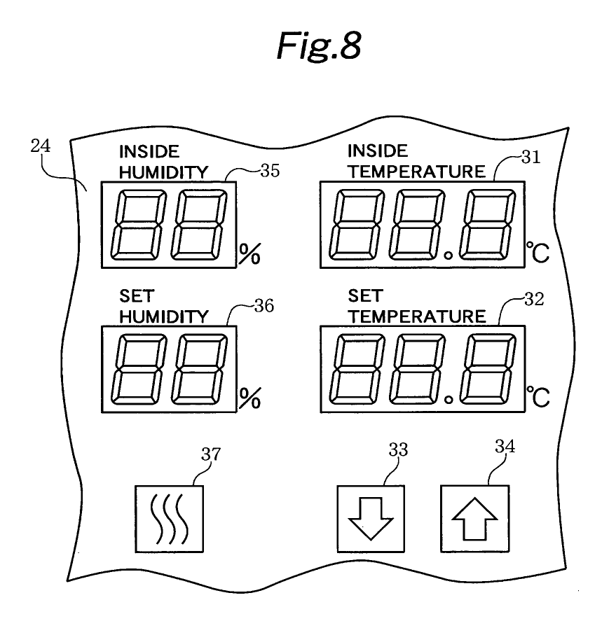

### BEST MODE FOR CARRYING OUT THE INVENTION

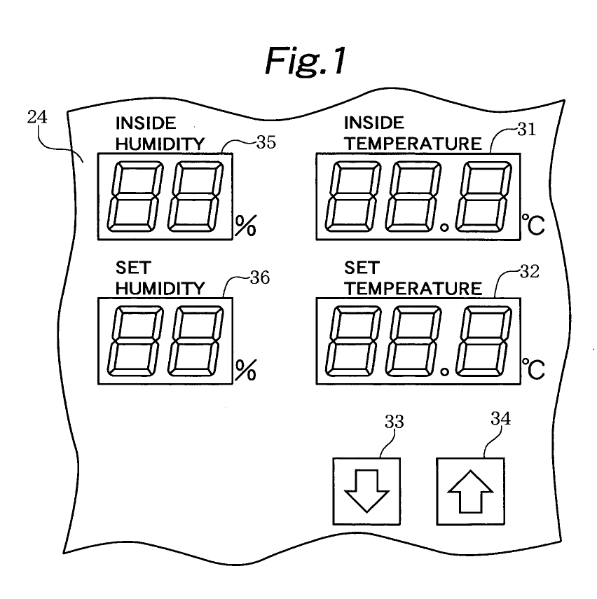

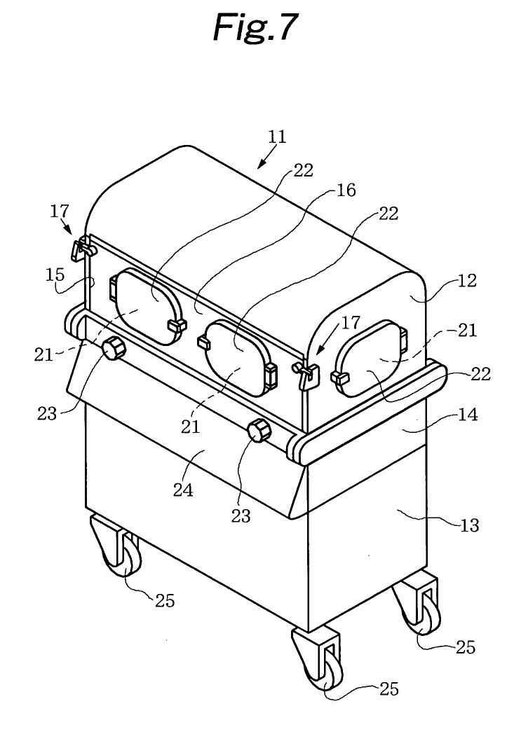

The first to fourth modes of the present invention will be explained with reference to FIGS. 1 to 7. FIG. 1 shows a part of a control panel 24 of an incubator 11 of the first mode. An overall exterior of the incubator 11 of this first mode is almost the same as that of the incubator 11 of the above one conventional mode, but the control panel 24 is not provided with the humidity setting button 37.

For this reason, in the incubator 11 of this first mode, it is the same as the incubator 11 of the above one conventional mode that a set temperature displayed on a set temperature display 32 is directed by pressing the direction buttons 33 and 34. However, it is different from the incubator 11 of the above one conventional mode that there is, in a base part 14, arranged a control part which determines a set humidity simultaneously and automatically according to a following formula when a set temperature is directed.

That is, the control part determines H as follows when let H be the set humidity (% relative humidity) and T be the set temperature (° C.).

| | |
|---|---|
| H = 95 | (36.0 ≦ T) |
| H = 95 − 10 × (36.0 − T) | (32.5 < T < 36.0) |
| H = 60 | (T ≦ 32.5) |

The set humidity determined by the control part is displayed on the set humidity display 36 on the control panel 24, and a humidity regulation part operates so that an inside humidity displayed on an inside humidity display 35 becomes equal to the set humidity. Therefore, even if a treating person does not direct or change the set humidity too simultaneously in case where the treating person directs the set temperature newly or change it, the control part determines the set humidity automatically to a value dependent upon the set temperature.

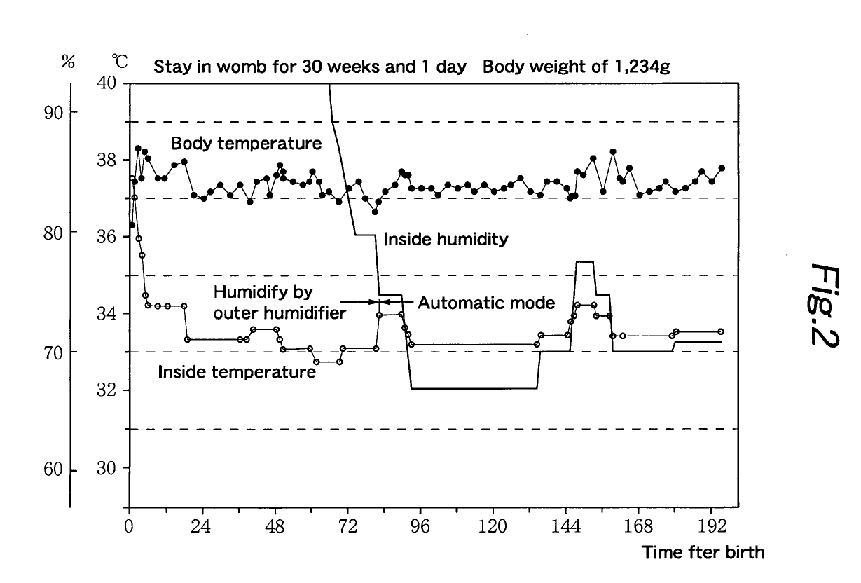

FIG. 2 shows a measured result of the inside temperature and the inside humidity of the incubator 11 and the body temperature of a low birth weight baby with respect to a time after birth in case where the low birth weight baby, who was born at body weight of 1,234 g after staying in a womb for 30 weeks and 1 day, is nursed in the incubator 11 of this first mode. It should be noted that, on the occasion of this measurement, the set humidity is not automatically determined by the control part but humidification by an external humidifier is performed till a time after birth of about 82 hours, and the set humidity is automatically determined by the control part only thereafter, as described in FIG. 2.

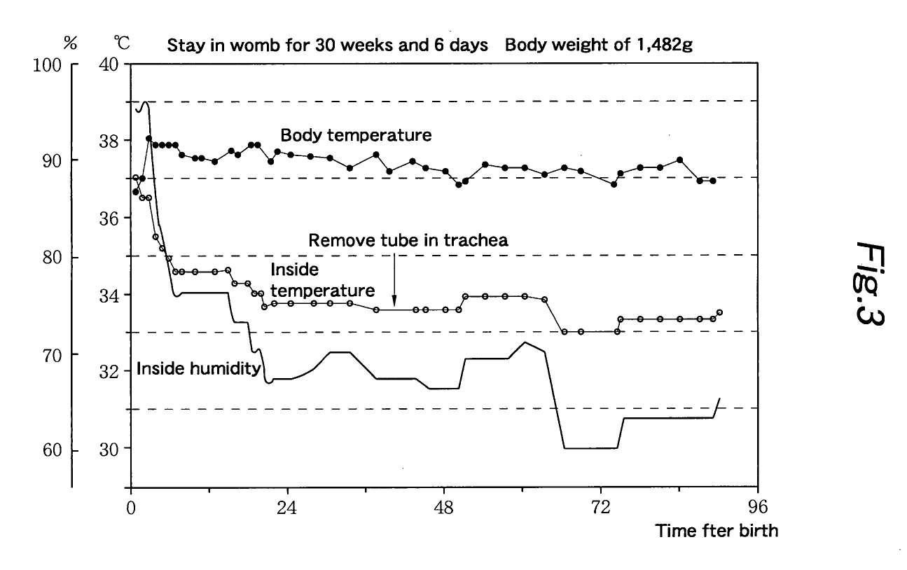

FIG. 3 shows a measured result similar to that of FIG. 2 in case where a low birth weight baby, who was born at body weight of 1,482 g after staying in a womb for 30 weeks and 6 days, is nursed in the incubator 11 of the second mode in which the control part determines the set humidity simultaneously and automatically according to a following formula when the set temperature is directed. It should be noted that, on the occasion of this measurement, the baby breathes through a tube inserted into a trachea till a time after birth of about 40 hours, and the baby changes to a spontaneous breath in an atmosphere in the incubator by removing the tube in the trachea thereafter, as described in FIG. 3. As is apparent from the following formula, being compared at the same set temperature, the set humidity in the incubator 11 of this second mode is lower by 5% than that in the incubator 11 of the first mode.

The control part in the incubator 11 of this second mode determines H as follows.

| | |
|---|---|
| H = 95 | (36.5 ≦ T) |
| H = 95 − 10 × (36.5 − T) | (33.0 < T < 36.5) |
| H = 60 | (T ≦ 33.0) |

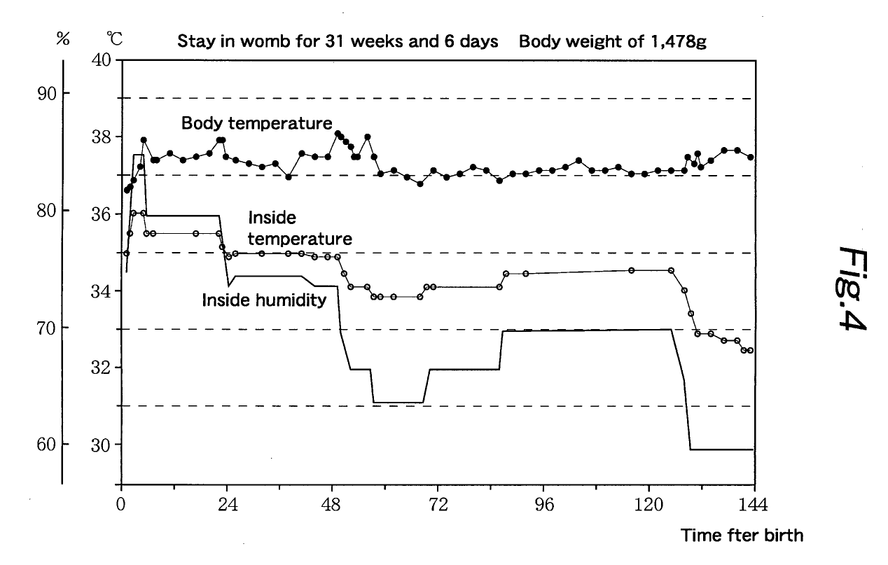

FIG. 4 shows a measured result similar to that of FIG. 2 in case where a low birth weight baby, who was born at body weight of 1,478 g after staying in a womb for 31 weeks and 6 days, is nursed in the incubator 11 of the third mode in which the control part determines the set humidity simultaneously and automatically according to a following formula when the set temperature is directed. As is apparent from the following formula, being compared at the same set temperature, the set humidity in the incubator 11 of this third mode is lower by 10% than that in the incubator 11 of the first mode.

The control part in the incubator 11 of this third mode determines H as follows.

| | |
|---|---|
| H = 95 | (37.0 ≦ T) |
| H = 95 − 10 × (37.0 − T) | (33.5 < T < 37.0) |
| H = 60 | (T ≦ 33.5) |

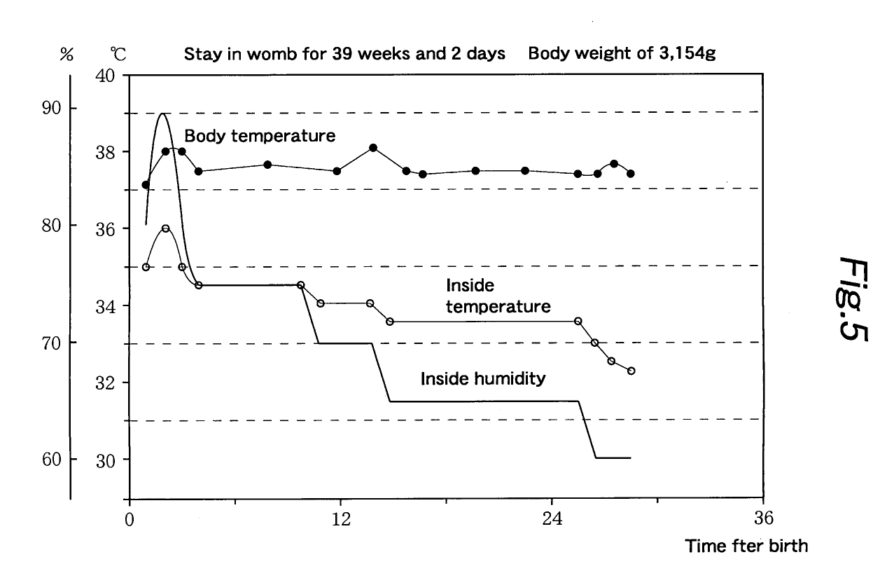

In addition, for reference, FIG. 5 shows a measured result similar to those of FIGS. 2 to 4 in case where a normal birth weight baby, who was born at body weight of 3,154 g after staying in a womb for 39 weeks and 2 days, is nursed in the incubator 11 of the above second mode. As shown in this FIG. 5, in case of a normal birth weight baby, the inside temperature of the incubator 11 is lowered to temperature close to room temperature in a relatively short time after birth and the inside humidity also lowers automatically with the lowering of the inside temperature.

Since a skin of a low birth weight baby, however, is immature, there is a lot of insensible perspiration from the skin and the body temperature is easy to lower. In order to prevent this lowering of the body temperature, as shown in FIGS. 2 to 4, in case of a low birth weight baby, the inside temperature of the incubator 11 is kept rather high for a long time after birth and the inside humidity is also kept rather high automatically with the keeping of the inside temperature. If a state of high humidity, however, is kept for a long time unnecessarily then breeding of bacterium is promoted and various infectious diseases are caused. For this reason, the inside temperature of the incubator 11 is lowered by degrees with maturity of the skin and the inside humidity also lowers automatically with the lowering of the inside temperature.

On the other hand, as shown in FIG. 5, in case of a normal birth weight baby, even if the inside temperature of the incubator 11 is lowered, the body temperature lowers hardly. Also in case of a low birth weight baby, even if the inside temperature of the incubator 11 is lowered, it is similarly necessary that the body temperature lowers hardly. In the measured result of FIG. 2, even if the inside temperature of the incubator 11 is lowered, the body temperature of the low birth weight baby lowers hardly like this. In the measured results of FIGS. 3 and 4, however, if the inside temperature of the incubator 11 is lowered then the body temperature of the low birth weight baby also lowers a little with the lowering of the inside temperature. From these circumstances, it can be seen that the incubator 11 of the first mode is superior to the incubators 11 of the second and third modes.

In any incubator 11 of the above first to third modes, the set humidity changes linearly with respect to the set temperature in a set temperature range between the highest set temperature of 36.0 to 37.0° C. and the lowest set temperature of 32.5 to 33.5° C. The set humidity, however, need not necessarily change linearly but need only show a positive correlation with respect to the set temperature.

On the other hand, as described above, being compared at the same set temperature, the set humidity in the incubators 11 of the second and third modes are lower by 5% and 10% respectively than that in the incubator 11 of the first mode. For this reason, to the contrary, it can be thought that the set humidity is raised than that of the incubator 11 of the first mode when compared at the same set temperature. If the set humidity is raised, however, than that of the incubator 11 of the first mode then condensation is easy to arise in the incubator and breeding of bacterium is promoted. Therefore, the control of the set humidity in the incubator 11 of the first mode is most desirable.

Now, the control of the set humidity in the incubator 11 of the first mode is most desirable for an incubated baby in an ordinary state. However, as the set humidity is not automatically determined by the control part but the humidification by the external humidifier is performed till a time after birth of about 82 hours in the measurement in FIG. 2, there are occasions when a predetermined humidity independent of the set temperature, particularly, high humidity is required in case where the state of the incubated baby is different from an ordinary state, e.g. a skin of the incubated baby is not yet mature or in other cases.

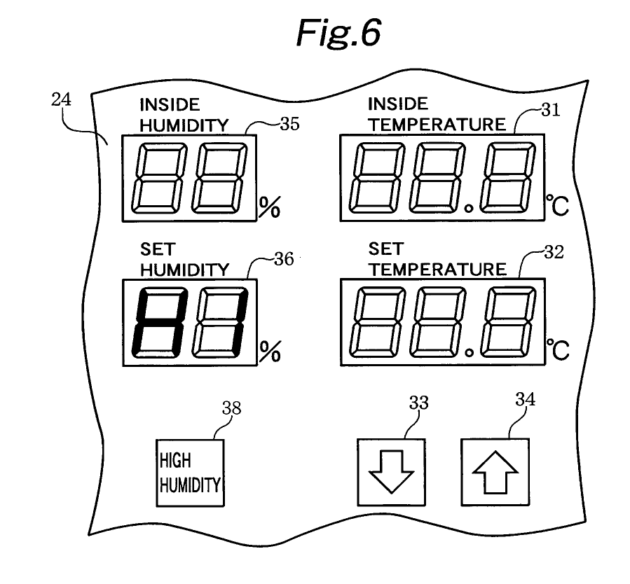

FIG. 6 shows a part of a control panel 24 in an incubator 11 of the fourth mode wherein the treatment of this manner also can be performed. In the incubator 11 of this fourth mode, the control panel 24 is provided with a high humidity direction button 38. When this high humidity direction button 38 is pushed, the control part does not adopt humidity determined in dependence upon the set temperature as the set humidity but adopts maximum 95% of the predetermined humidity as the set humidity.

In this case, if '951 is displayed on a set humidity display 36 then there is a possibility that a treating person judges wrongly whether the control part determines 95% dependent upon the set temperature as the set humidity or 95% of the predetermined humidity is directed as the set humidity and also judges wrongly to change a direct as a result. For this reason, in the incubator 11 of this fourth mode, the set humidity display 36 serves as the predetermined humidity direction display, too, and ‘HI’ is displayed on the set humidity display 36 as shown in FIG. 6.

In the above fourth mode, maximum 95% of the predetermined humidity is directed as the set humidity by pressing the high humidity direction button 38. However, humidity except 95% may be adopted as the predetermined humidity and the predetermined humidity may be changed from the outside, e.g. by operating the control panel 24.

Furthermore, in any incubator 11 of the above first to fourth modes, the set temperature is directed by the direction buttons 33 and 34. However, it may be thought that a sensor responsive to body temperature of an incubated baby accommodated in the incubator determines the set temperature automatically and a treating person need not direct the set temperature by the direction buttons 33 and 34.

### INDUSTRIAL APPLICABILITY

The present invention can be applied to an incubator for nursing an incubated baby such as a low birth weight baby.

1. An incubator comprising:
a temperature regulation part for regulating an inside temperature to a directed set temperature;
a control part for determining a set humidity in dependence upon said set temperature; and
a humidity regulation part for regulating an inside humidity to said set humidity.

2. An incubator as claimed in claim 1, wherein said control part determines H as follows when let said H be said set humidity, T be said set temperature and f(T) be a function showing a positive correlation with respect to T within a range of Tₘᵢₙ<T<Tₘₐₓ.

| | |
|---|---|
| H = f(Tₘₐₓ) | (Tₘₐₓ ≦ T) |
| H = f(T) | (Tₘᵢₙ < T < Tₘₐₓ) |
| H = f(Tₘᵢₙ) | (T ≦ Tₘᵢₙ) |

3. An incubator as claimed in claim 1, further comprising a sensor for determining said set temperature in response to body temperature of an incubated baby accommodated in the incubator.

4. An incubator as claimed in claim 1, further comprising a predetermined humidity direction part for directing a predetermined humidity independent of said set temperature as said set humidity.

5. An incubator as claimed in claim 4, further comprising a predetermined humidity direction display for displaying a direction by said predetermined humidity direction part.

6. An incubator as claimed in claim 5, wherein a set humidity display for displaying said set humidity serves as said predetermined humidity direction display, too.

7. An incubator as claimed in any one of claims 4, wherein said predetermined humidity can be changed.

8. An incubator as claimed in claim 2, further comprising a predetermined humidity direction part for directing a predetermined humidity independent of said set temperature as said set humidity.

9. An incubator as claimed in claim 8, further comprising a predetermined humidity direction display for displaying a direction by said predetermined humidity direction part.

10. An incubator as claimed in claim 9, wherein a set humidity display for displaying said set humidity serves as said predetermined humidity direction display, too.

11. An incubator as claimed in any one of claims 8, wherein said predetermined humidity can be changed.
